(19) United States
(12) Patent Application Publication
(10) Pub. No.: US 2020/0348462 A1
(43) Pub. Date: Nov. 5, 2020

(54) FILM FOR LED LIGHTING EQUIPMENT, AND LED LIGHTING EQUIPMENT

(71) Applicant: NITTO DENKO CORPORATION, Osaka (JP)

(72) Inventors: Daisuke Hattori, Ibaraki-shi (JP); Kozo Nakamura, Ibaraki-shi (JP); Atsushi Kishi, Ibaraki-shi (JP)

(73) Assignee: NITTO DENKO CORPORATION, Osaka (JP)

(21) Appl. No.: 16/936,736

(22) Filed: Jul. 23, 2020

Related U.S. Application Data
(63) Continuation-in-part of application No. PCT/JP2019/002037, filed on Jan. 23, 2019.

(30) Foreign Application Priority Data
Jan. 26, 2018 (JP) 2018-011998

(51) Int. Cl. F21V 8/00

(52) U.S. Cl. CPC G02B 6/0043; G02B 6/0065; G02B 6/0073

(57) ABSTRACT

Provided are: a film for an LED lighting apparatus, which allows the front surface and/or back surface of a light guide unit to have any appropriate film laminated thereon, or to be subjected to any appropriate surface treatment, while suppressing a reduction in waveguide efficiency of light in a lighting apparatus having an LED light source arranged on one end surface of a light guide plate and being configured to emit light from an end surface opposed to the end surface (entrance end surface) on which the LED light source is arranged; and an LED lighting apparatus including the film for an LED lighting apparatus. The film for an LED lighting apparatus of the present invention includes: a base material; and a low-refractive index layer arranged on at least one side of the base material. In one embodiment, the low-refractive index layer has a refractive index of 1.25 or less.

### CROSS-REFERENCE TO RELATED APPLICATIONS

The present patent application is a Continuation-in-Part of a National Stage of PCT Application No. PCT/JP2019/002037, filed Jan. 23, 2019, claiming priority to Japanese Application No. 2018-011998, filed Jan. 26, 2018, each of which is incorporated herein by reference in its entirety.

### TECHNICAL FIELD

The present invention relates to a film for an LED lighting apparatus and an LED lighting apparatus using the same.

### BACKGROUND ART

As a lighting apparatus excellent in design property, there is known an LED lighting apparatus configured to perform lighting by using an LED as a light source and radiating light via a light guide plate, the lighting apparatus having the LED light source on one end surface of the light guide plate and being configured to emit rod-shaped light from an end surface opposed to the end surface (entrance end surface) on which the LED light source is arranged. In such lighting apparatus, in order to enhance emission efficiency, the light needs to be guided by total reflection at a main surface of the light guide plate, and hitherto, the light guide plate has been configured to be exposed in many cases. However, the light guide plate configured as just described is liable to be fouled with dust, a fingerprint, or the like, resulting in a problem in that the fouling adhering to the light guide plate interferes with the total reflection of light. In addition, when an antifouling layer is arranged on the light guide plate, there arises a problem in that the layer interferes with the total reflection in the guiding of light. In addition, when a film (e.g., a protective film or a design film) is arranged on the main surface of the light guide plate, the guiding of light by the total reflection at the main surface becomes insufficient, resulting in a reduction in emission intensity.

### CITATION LIST

### Patent Literature

[PTL 1] JP 2017-47677 A

### SUMMARY OF INVENTION

### Technical Problem

An object of the present invention is to provide: a film for an LED lighting apparatus, which allows the front surface and/or back surface of a light guide unit to have any appropriate film laminated thereon, or to be subjected to any appropriate surface treatment, while suppressing a reduction in waveguide efficiency of light in a lighting apparatus having an LED light source arranged on one end surface of a light guide plate and being configured to emit light from an end surface opposed to the end surface (entrance end surface) on which the LED light source is arranged; and an LED lighting apparatus including the film for an LED lighting apparatus.

### Solution to Problem

According to one embodiment of the present invention, there is provided a film for an LED lighting apparatus, including: a base material; and a low-refractive index layer arranged on at least one side of the base material, wherein the low-refractive index layer has a refractive index of 1.25 or less.

In one embodiment, the low-refractive index layer is a void-containing layer.

In one embodiment, the low-refractive index layer has a void ratio of 35 vol % or more.

According to another embodiment of the present invent ion, there is provided an LED lighting apparatus. The LED lighting apparatus includes: a light guide plate; and a low-refractive index layer arranged on at least one surface of the light guide plate.

In one embodiment, the LED lighting apparatus includes: alight guide unit including the light guide plate and a film for an LED lighting apparatus, which is arranged on at least one surface of the light guide plate; and an LED light source arranged on one end surface of the light guide plate, wherein the film for an LED lighting apparatus is the film for an LED lighting apparatus, and wherein the film for an LED lighting apparatus is directly arranged on the light guide plate in such a manner that the low-refractive index layer is arranged inside with respect to the base material.

In one embodiment, a difference between a refractive index of the light guide plate and a refractive index of the low-refractive index layer is 0.2 or more.

### Advantageous Effects of Invention

The film for an LED lighting apparatus of the present invention includes the low-refractive index layer having a refractive index of 1.25 or less. The use of the film for an LED lighting apparatus can provide: the film for an LED lighting apparatus, which allows the front surface and/or back surface of the light guide unit to have any appropriate film laminated thereon, or to be subjected to any appropriate surface treatment, while suppressing a reduction in waveguide efficiency of light in a lighting apparatus having the LED light source on one end surface of the light guide plate and being configured to emit rod-shaped light from the end surface opposed to the end surface (entrance end surface) on which the LED light source is arranged; and the LED lighting apparatus including the film for an LED lighting apparatus.

### BRIEF DESCRIPTION OF DRAWINGS

FIG. 1 is a schematic cross-sectional view of a film for an LED lighting apparatus according to one embodiment of the present invention.

FIG. 2 is a schematic cross-sectional view of an LED lighting apparatus including the film for an LED lighting apparatus according to one embodiment of the present invention.

### DESCRIPTION OF EMBODIMENTS

### A. Film for LED Lighting Apparatus

### A-1. Outline of Film for LED Lighting Apparatus

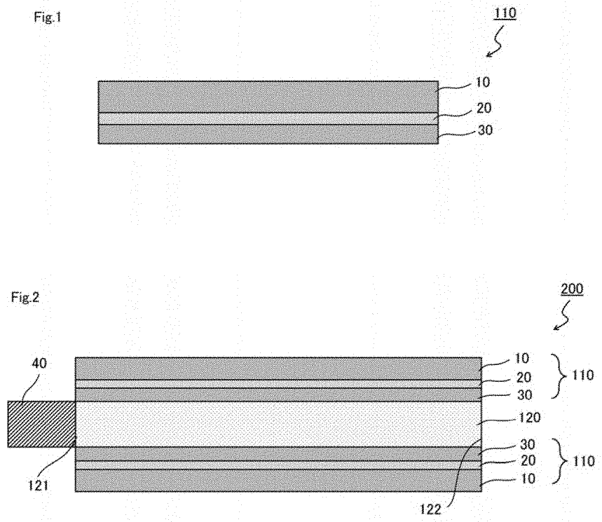

FIG. 1 is a schematic cross-sectional view of a film for an LED lighting apparatus according to one embodiment of the present invention. A film 110 for an LED lighting apparatus according to this embodiment includes a base material 10 and a low-refractive index layer 20 arranged on at least one side of the base material 10. The low-refractive index layer 20 has a refractive index of 1.25 or less. The film 110 for an LED lighting apparatus may further include an adhesion layer 30 on the opposite side of the low-refractive index layer 20 to the base material 10 as required. The film 110 for an LED lighting apparatus is preferably free of any layer other than the adhesion layer 30 on the opposite side of the low-refractive index layer 20 to the base material 10. The film for an LED lighting apparatus of the present invention may further include an adhesion layer (not shown) on the opposite side of the base material to the low-refractive index layer as required. In addition, the film for an LED lighting apparatus of the present invention may have a release liner arranged on the outer side of the adhesion layer for the purpose of protecting its adhesion surface until use. As used herein, the concept “adhesion layer” encompasses a pressure-sensitive adhesive layer and an adhesive layer.

FIG. 2 is a schematic cross-sectional view of an LED lighting apparatus including the film for an LED lighting apparatus according to one embodiment of the present invention. An LED lighting apparatus 200 includes: a light guide unit 100 including a light guide plate 120 and the film 110 for an LED lighting apparatus, which is arranged on at least one surface (both surfaces in the illustrated example) of the light guide plate 120; and an LED light source 40 arranged on one end surface (surface approximately perpendicular to the film 110 for an LED lighting apparatus) of the light guide plate 120. The LED lighting apparatus 200 is configured to perform lighting by using an LED as a light source and radiating light via the light guide plate 120. More specifically, the LED lighting apparatus 200 has the LED light source 40 arranged on one end surface 121 of the light guide plate 120 and is configured to emit light, in a shape corresponding to an end surface shape, from an end surface 122 (hereinafter sometimes referred to as emission end surface) opposed to the end surface 121 (hereinafter sometimes referred to as entrance end surface) on which the LED light source 40 is arranged. A member (not shown) for diffusing emitted light, such as a light-diffusing plate, may be arranged on the emission end surface. In addition, the shape of the emission end surface is not particularly limited, and may be, other than the illustrated example, an inclined surface inclined with respect to the film for an LED lighting apparatus, or an uneven surface. The film 110 for an LED lighting apparatus is preferably directly arranged on the light guide plate 120 in such a manner that the low-refractive index layer 20 is arranged inside (light guide plate side) with respect to the base material 10. The light guide unit 100 typically has a flat plate shape. In one embodiment, the light guide unit 100 having a flat plate shape may be used with part thereof being curved depending on a desired emission direction of light.

When the film for an LED lighting apparatus of the present invention is used as described above, there can be obtained an LED lighting apparatus capable of satisfactorily reflecting light at an interface between the light guide plate and the film for an LED lighting apparatus, thereby being excellent in waveguide efficiency of light and excellent in intensity of emission from the emission end surface. In addition, light can be satisfactorily reflected at the interface between the light guide plate and the film for an LED lighting apparatus, and hence there can be obtained an LED lighting apparatus excellent in waveguide efficiency of light irrespective of the condition of the surface of the film for an LED lighting apparatus on the opposite side to the light guide plate. Specifically, the LED lighting apparatus is not reduced in waveguide efficiency of light even when fouling adheres to the outer side of the light guide unit (substantially the outer side of the film for an LED lighting apparatus). In addition, the LED lighting apparatus is not reduced in waveguide efficiency of light even when any appropriate film, such as a design film, is further arranged on the outer side of the light guide unit. Further, the waveguide efficiency of light is not reduced even when the outer side of the light guide unit is subjected to surface treatment, such as antifouling treatment.

### A-2.Low-Refractive Index Layer

As described above, the low-refractive index layer has a refractive index of 1.25 or less. When a film for an LED lighting apparatus including a low-refractive index layer having such refractive index is laminated on the light guide plate, there can be obtained an LED lighting apparatus capable of satisfactorily reflecting light at the interface between the light guide plate and the film for an LED lighting apparatus, thereby being excellent in waveguide efficiency of light and excellent in intensity of emission from the emission end surface. The refractive index of the low-refractive index layer is preferably 1.23 or less, more preferably 1.20 or less, still more preferably 1.18 or less, particularly preferably 1.15 or less. The refractive index of the low-refractive index layer is preferably as low as possible, but the lower limit thereof is, for example, 1.07 or more (preferably 1.05 or more). As used herein, the term “refractive index” refers to a refractive index measured at a wavelength of 550 nm.

The thickness of the low-refractive index layer is preferably from 0.01 μm to 1,000 μm, more preferably from 0.05 μm to 100 μm, still more preferably from 0.1 μm to 80 μm, particularly preferably from 0.3 μm to 50 μm.

The low-refractive index layer may have any appropriate form as long as its refractive index falls within the above-mentioned ranges. In one embodiment, the low-refractive index layer is configured to be a void-containing layer having predetermined voids.

The void ratio of the low-refractive index layer having voids is preferably 35 vol % or more, more preferably 38 vol % or more, particularly preferably 40 vol % or more. When the void ratio falls within such ranges, a low-refractive index layer having a particularly low refractive index can be formed. The upper limit of the void ratio of the low-refractive index layer is, for example, 90 vol % or less, preferably 75 vol % or less. When the void ratio falls within such ranges, a low-refractive index layer excellent in strength can be formed. When the layer to be subjected to the measurement of the void ratio is merely a single layer containing voids, a ratio (volume ratio) between a material forming the layer and air may be calculated by a conventional method (involving, for example, measuring the weight and volume of the layer and calculating the density thereof), and hence the void ratio (vol %) may be thus calculated. In addition, the refractive index and the void ratio correlate with each other, and hence, for example, the void ratio may also be calculated from the value of the refractive index as a layer. Specifically, for example, the void ratio is calculated by Lorentz-Lorenz's formula from the value of the refractive index measured with an ellipsometer.

The size of each of the voids is preferably from 2 nm to 500 nm, more preferably from 5 nm to 500 nm, still more preferably from 10 nm to 200 nm, particularly preferably from 20 nm to 100 nm. The size of each of the voids may be measured by a BET test method. Specifically, the void size may be evaluated from a pore distribution obtained by: loading 0.1 g of a low-refractive index layer sample into a capillary of a specific surface area measurement apparatus (product name: “ASAP2020”, manufactured by Micromeritics Instrument Corporation); then removing gas in its void structure through drying under reduced pressure at room temperature for 24 hours; and then adsorbing a nitrogen gas onto the low-refractive index layer sample.

The peak pore diameter of the low-refractive index layer having voids is preferably from 5 nm to 50 nm, more preferably from 10 nm to 40 nm, still more preferably from 20 nm to 30 nm. The peak pore diameter is determined from a BJH plot and a BET plot, and an isothermal adsorption curve, each of which is based on nitrogen adsorption, through use of a pore distribution/specific surface area measurement apparatus (product name: “BELLSORP MINI”, from MicrotracBEL Corp.).

The low-refractive index layer having voids contains, for example, approximately spherical particles, such as silicone particles, silicone particles having fine pores, or silica hollow nanoparticles, fibrous particles, such as a cellulose nanofiber, an alumina nanofiber, or a silica nanofiber, or flat plate-like particles, such as nanoclay formed of bentonite. In one embodiment, the low-refractive index layer having voids is a porous body formed by chemical bonding between particles. In addition, at least some of the particles forming the low-refractive index layer having voids may be bonded to each other via a small amount of a binder component (e.g., a binder component having a weight equal to or smaller than that of the particles). The void ratio and refractive index of the low-refractive index layer having voids may be adjusted on the basis of, for example, the particle diameters and particle diameter distribution of the particles forming the low-refractive index layer.

As a method of obtaining the low-refractive index layer having voids, there are given, for example, methods described in JP 2010-189212 A, JP 2008-040171 A, JP 2006-011175 A, WO 2004/113966 A1, and references thereof. Specific examples thereof include: a method involving hydrolyzing and polycondensing at least one of a silica-based compound, or a hydrolyzable silane, or a partial hydrolysate or dehydration condensate thereof; a method involving using porous particles and/or hollow fine particles; a method involving utilizing a spring-back phenomenon to produce an aerogel layer; and a method involving using a pulverized gel, which is obtained by pulverizing a gel obtained by a sol-gel method and chemically bonding fine porous particles in the pulverized liquid to each other with a catalyst or the like. However, the low-refractive index layer may be produced by any production method, which is not limited to the above-mentioned production methods.

The low-refractive index layer having voids is preferably a silicone porous body. The silicone porous body may be formed of fine porous particles of a silicon compound that are bonded to each other. An example of the fine porous particles of a silicon compound is a pulverized product of a gelled silicon compound. The silicone porous body may be formed by, for example, applying an application liquid containing the pulverized product of a gelled silicon compound to a base material. In one embodiment, the pulverized product of a gelled silicon compound may be subjected to, for example, the action of a catalyst, light irradiation, or heating, to form a chemical bond (e.g., a siloxane bond).

An example of the silicon compound is a compound represented by the following formula (1).

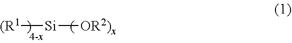

In the formula (1), X represents 2, 3, or 4. R¹ represents preferably a linear or branched alkyl group having 1 to 6 carbon atoms, more preferably a linear or branched alkyl group having 1 to 4 carbon atoms, still more preferably an alkyl group having 1 or 2 carbon atoms. R² represents preferably a hydrogen atom or a linear or branched alkyl group having 1 to 6 carbon atoms, more preferably a hydrogen atom or a linear or branched alkyl group having 1 to 4 carbon atoms, still more preferably a hydrogen atom or an alkyl group having 1 or 2 carbon atoms.

Specific examples of the silicon compound include tris(hydroxy)methylsilane and trimethoxy(methyl)silane.

In one embodiment, the silicon compound is a trifunctional silane. When the trifunctional silane is used, a low-retractive index layer having a particularly low refractive index can be formed. In another embodiment, the silicon compound is a tetrafunctional silane. When the tetrafunctional silane is used, a low-refractive index layer excellent in scratch resistance can be formed.

The gelation of the silicon compound may be performed by, for example, a dehydration condensation reaction of the silicon compound. Any appropriate method may be adopted as a method for the dehydration condensation reaction.

Any appropriate method may be adopted as a pulverization method for the gelled silicon compound. An example of the pulverization method is a method involving using a pulverization apparatus making use of a cavitation phenomenon, such as an ultrasonic homogenizer or a high-speed rotating homogenizer.

The volume-average particle diameter of the fine porous particles of a silicon compound (pulverized product of a gelled silicon compound) is preferably from 0.1 μm to 2 μm, more preferably from 0.2 μm to 1.5 μm, still more preferably from 0.4 μm to 1 μm. The volume-average particle diameter may be measured by a dynamic light scattering method.

With regard to the particle size distribution of the fine porous particles of a silicon compound (pulverized product of a gelled silicon compound), the ratio of particles each having a particle diameter of from 0.4 μm to 1 μm to all particles is preferably from 50 wt % to 99.9 wt % or more preferably from 30 wt % to 99.8 wt %, still more preferably from 90 wt % to 99.7 wt %. In addition, the ratio of particles each having a particle diameter of from 1 μm to 2 μm to all particles is preferably from 0.1 wt % to 50 wt %, more preferably from 0.2 wt % to 20 wt %, still more preferably from 0.3 w t% to 10 wt %. The particle size distribution may be measured with a particle size distribution evaluation apparatus.

### A-3. Base Material

The base material may be formed of any appropriate material. As a material for forming the base material, there are given, for example: thermoplastic resins, such as a polyethylene terephthalate-based resin, an acrylic resin, a cellulose-based resin, a cycloolefin-based resin, and an olefin-based resin; thermosetting resins; inorganic materials, such as glass and silicon; and carbon fiber materials.

The thickness of the base material is not particularly limited, and may be set to any appropriate thickness depending on applications. The thickness of the base material is, for example, from 1 μm to 1,000 μm.

### A-4. Adhesion Layer

The adhesion layer contains any appropriate pressure-sensitive adhesive or adhesive. The pressure-sensitive adhesive and the adhesive each preferably have transparency and optical isotropy. Specific examples of the pressure-sensitive adhesive include a rubber-based pressure-sensitive adhesive, an acrylic pressure-sensitive adhesive, a silicone-based pressure-sensitive adhesive, an epoxy-based pressure-sensitive adhesive, and a cellulose-based pressure-sensitive adhesive. Of those, a rubber-based pressure-sensitive adhesive or an acrylic pressure-sensitive adhesive is preferred. Specific examples of the adhesive include a rubber-based adhesive, an acrylic adhesive, a silicone-based adhesive, an epoxy-based adhesive, and a cellulose-based adhesive. In addition, a pressure-sensitive adhesive or adhesive formed of, for example, a water-soluble cross-linking agent for a vinyl alcohol-based polymer, such as glutaraldehyde, melamine, or oxalic acid, may be used.

The thickness of the adhesion layer is preferably from 0.1 μm to 100 μm, more preferably from 5 μm to 50 μm, still more preferably from 10 μm to 30 μm.

The refractive index of the adhesion layer is preferably from 1.42 to 1.60, more preferably from 1.47 to 1.58. When the refractive index fails within such ranges, there can be obtained an LED lighting apparatus excellent in waveguide efficiency of light and excellent in intensity of emission from the emission end surface.

### A-5. Production Method for Film for LED Lighting Apparatus

The film for an LED lighting apparatus may be produced by any appropriate method. For example, the film for an LED lighting apparatus including the base material and the low-refractive index layer may be obtained by applying an application liquid containing predetermined particles (e.g., the fine porous particles of a silicon compound, preferably the pulverized product of a gelled silicon compound) onto the base material, followed by drying.

The application liquid contains any appropriate solvent. Examples of the solvent include isopropyl alcohol, ethanol, methanol, n-butanol, 2-butanol, isobutyl alcohol, and pentanol.

In one embodiment, the application liquid further contains a catalyst. A catalyst capable of promoting the chemical bonding of the particles is used as the catalyst. For example, when the fine porous particles of a silicon compound are used as the particles, a catalyst capable of promoting a dehydration condensation reaction of silanol groups of the silicon compound is used. Examples of the catalyst include: base catalysts, such as potassium hydroxide, sodium hydroxide, and ammonium hydroxide; and acid catalysts, such as hydrochloric acid, acetic acid, and oxalic acid. Of those, a base catalyst is preferred. The content ratio of the catalyst is preferably from 0.01 part by weight to 20 parts by weight, more preferably from 0.1 part by weight to 5 parts by weight with respect to 100 parts by weight of the particles in the application liquid.

Any appropriate method may be adopted as an application method for the application liquid. Examples of the application method include bar coater coating, air knife coating, gravure coating, gravure reverse coating, reverse roll coating, lip coating, die coating, and dip coating.

Any appropriate method may be adopted as a drying method for the application liquid. The drying method for the application liquid may be natural drying, drying by heating, or drying under reduced pressure. As heating means, there are given, for example, a hot air fan, a heating roll, and a far-infrared heater.

The production method for the film for an LED lighting apparatus may include a heating step. The heating step can promote bonding between the particles forming the low-refractive index layer. For example, when the fine porous particles of a silicon compound are used as the particles, a heating temperature is preferably 200° C. or more. The drying step may double as the heating step.

The details of a production method for a film including a low-retractive index layer are described in, for example, JP 2017-47677 A, the description of which is incorporated herein by reference.

### B. LED Lighting Apparatus

An LED lighting apparatus of the present invention includes a light guide plate and a low-refractive index layer arranged on at least one surface of the light guide plate. In one embodiment, the film for an LED lighting apparatus is laminated on the light guide plate to provide an LED lighting apparatus including a low-refractive index layer. In this embodiment, as illustrated in FIG. 2, the LED lighting apparatus 200 includes: the light guide unit 100 including the light guide plate 120 and the film 110 for an LED lighting apparatus, which is arranged on at least one surface (both surfaces in the illustrated example) of the light guide plate 120; and the LED light source 40 arranged on one end surface (surface approximately perpendicular to the film 110 for an LED lighting apparatus) of the light guide plate 120. The film 100 for an LED lighting apparatus is preferably directly arranged on the light guide plate in such a manner that the low-refractive index layer 20 is arranged inside (light guide plate side) with respect to the base material 10. The term “directly arranged” means that the film 100 for an LED lighting apparatus and the light guide plate 120 are arranged without any other layer arranged between the film 100 for an LED lighting apparatus and the light guide plate 120. The LED lighting apparatus may further include any appropriate other member. For example, a member for diffusing emitted light, such as a light-diffusing plate, may be arranged on the emission end surface.

Any appropriate material may be used as a material for forming the light guide plate as long as light, radiated from the LED light source can be efficiently guided. Examples of the material for forming the light guide plate include an acrylic resin, a polycarbonate-based resin, and a cycloolefin-based resin. The thickness of the light guide plate is, for example, from 100 μm to 1,000 μm. The shape of the emission end surface of the light guide plate is not particularly limited, and may be, other than the illustrated example, an inclined surface inclined with respect to the film for an LED lighting apparatus, or an uneven surface.

The refractive index of the light guide plate is preferably 1.4 or more, more preferably more than 1.45, still more preferably more than 1.45 and 2 or less, particularly preferably from 1.48 to 1.8.

A difference between the refractive index of the light guide plate and the refractive index of the low-refractive index layer is preferably 0.2 or more, more preferably 0.23 or more, still more preferably 0.25 or more. When the difference falls within such ranges, there can be obtained an LED lighting apparatus capable of satisfactorily reflecting light at the interface between the light guide plate and the film for an LED lighting apparatus, thereby being excellent in waveguide efficiency of light and excellent in intensity of emission from the emission end surface. In general, the refractive index of the light guide plate is higher than the refractive index of the low-refractive index layer.

### EXAMPLES

Now, the present invention is specifically described by way of Examples. However, the present invention is by no means limited to these Examples. Evaluation methods in Examples and Comparative Examples are as described below. In addition, the terms “part(s)” and “%” are by weight unless otherwise stated.

### Evaluation Methods

### (1) Refractive Index

A refractive index layer was cut into a size of 50 mm×50 mm, and the resultant was bonded to the front surface of a glass plate (thickness: 3 mm) via a pressure-sensitive adhesion layer. A central portion (diameter: about 20 mm) of the back surface of the glass plate was painted over with a black felt-tip pen to provide a sample prevented from reflection at the back surface of the glass plate. The sample was set in an ellipsometer (manufactured by J.A. Woollam Japan: VASE), and its refractive index was measured under the conditions of a wavelength of 500 nm and an incident angle of from 50° to 80°.

### (2) Void Ratio

A void ratio was calculated by Lorentz-Lorenz's formula from the value of the refractive index measured with the ellipsometer.

### (3) Ratio of Intensity of Light Emitted from Light Guide Plate to Intensity of Light Entering Light Guide Plate

A spectroradiometer SR-UL2 (manufactured by Topcon Technohouse Corporation) was used to determine a ratio between the brightness measurement result of an LED alone before the entrance of light into a light guide plate (entering light intensity) and the brightness measurement result of light emitted from the terminal end of the light guide plate after the entrance of light from the LED into the light guide plate (emitted light brightness).

### [Production Example 1] Preparation of Application Liquid for Forming Low-Refractive Index Layer

### (1) Gelation of Silicon Compound

0.95 g of MTMS serving as a precursor of a silicon compound was dissolved in 2.2 g of DMSO to prepare a mixed liquid A. To the mixed liquid A, 0.5 g of a 0.01 mol/L oxalic acid aqueous solution was added, and the mixture was stirred at room temperature for 30 minutes to hydrolyze MTMS. Thus, a mixed liquid B containing tris(hydroxy)methylsilane was produced.

0.38 g of 28 wt % ammonia water and 0.2 g of pure water were added to 5.5 g of DMSO, and then the mixed liquid B was further added. The mixture was stirred at room temperature for 15 minutes to perform gelation of tris(hydroxy)methylsilane. Thus, a mixed liquid C containing a gelled silicon compound was obtained.

### (2) Maturation Treatment

The mixed liquid C containing the gelled silicon compound prepared as described above was subjected as it was to maturation treatment by being incubated at 40° C. for 20 hours.

### (3) Pulverization Treatment

Next, the gelled silicon compound subjected to maturation treatment as described above was crushed using a spatula into granules each having a size of from several mm to several cm. Then, 40 g of IBA was added to the mixed liquid C, and the whole was lightly stirred and then left to stand still at room temperature for 6 hours to decant the solvent and the catalyst in the gel. Similar decantation treatment was performed three times to perform solvent replacement, to thereby provide a mixed liquid D. Then, the gelled silicon compound in the mixed liquid D was subjected to pulverization treatment (high-pressure media-less pulverization). The pulverization treatment (high-pressure media-less pulverization) was performed by weighing 1.85 g of the gelled compound in the mixed liquid D′ and 1.15 g of IBA into a 5 cc screw-capped vial and then pulverizing the contents under the conditions of 50 W and 20 kHz for 2 minutes through use of a homogenizer (manufactured by SMT Co., Ltd., product name: “UH-50”).

As a result of the pulverization treatment, the gelled silicon compound in the mixed liquid D was pulverized, and thus the mixed liquid D′ became a sol liquid of a pulverized product. A volume-average particle diameter indicating a variation in particle size of the pulverized product contained in the mixed liquid D′ was found to be from 0.50 to 0.70 with a dynamic light scattering Nanotrac particle size analyzer (manufactured by Nikkiso Co., Ltd., model UPA-EX150). Further, to 0.75 g of the sol liquid (mixed liquid C′), a solution of a photobase generator (Wako Pure Chemical Industries, Ltd.: product name: WPBG-266) in methyl ethyl ketone (MEK) at a concentration of 1.5 wt % and a solution of bis(trimethoxysilyl)ethane in MEK at a concentration of 5% were added at a ratio of 0.062 g:0.036 g to provide an application liquid for a low-refractive index layer.

### [Production Example 2] Production of Pressure-Sensitive Adhesion Layer

A four-necked flask with a stirring blade, a temperature gauge, a nitrogen gas inlet tube, and a condenser was loaded with 90.7 parts of butyl acrylate, 6 parts of N-acryloylmorpholine, 3 parts of acrylic acid, 0.3 part of 2-hydroxybutyl acrylate, and 0.1 part by weight of 2,2′-azobisisobutyronitrile serving as a polymerization initiator together with 100 g of ethyl acetate. While the contents were gently stirred, a nitrogen gas was introduced to perform nitrogen purge. After that, with the liquid temperature in the flask being kept around 55° C., a polymerization reaction was performed for 3 hours to prepare an acrylic polymer solution. With respect to 100 parts of the solid content of the resultant acrylic polymer solution, 0.2 part of an isocyanate cross-linking agent (CORONATE L manufactured by Nippon Polyurethane Industry Co., Ltd., tolylene diisocyanate adduct of trimethylolpropane), 0.3 part of benzoyl peroxide (NYPER BMT manufactured by Nippon Oil & Fats Co., Ltd.), and 0.2 part of γ-glycidoxypropylmethoxysilane (manufactured by Shin-Etsu Chemical Co., Ltd.: KBM-403) were blended to prepare an acrylic pressure-sensitive adhesive solution. Then, the acrylic pressure-sensitive adhesive solution was applied to one surface of a silicone-treated polyethylene terephthalate (PET) film (manufactured by Mitsubishi Polyester Film Corporation, thickness: 38 μm) so that a pressure-sensitive adhesive layer after drying had a thickness of 10 μm, and the applied solution was dried at 150° C. for 3 minutes to form the pressure-sensitive adhesive layer.

### Example 1

The application liquid for a low-refractive index layer prepared in Production Example 1 was applied to an acrylic resin film (thickness: 20 μm) serving as a base material, and was dried to provide a laminate in which a low-refractive index layer (refractive index: 1.18) having a thickness of 850 nm was arranged on one surface of the base material. The low-refractive index layer was subjected to UV (300 mJ) irradiation, and then the pressure-sensitive adhesive layer of Production Example 2 was transferred onto the low-refractive index layer, followed by aging at 60° C. for 20 hours, to provide a film for an LED lighting apparatus (base material/low-refractive index layer/pressure-sensitive adhesive layer).

The resultant film for an LED lighting apparatus was directly bonded to each of both surfaces of a light guide plate (acrylic light guide plate, refractive index: 1.49) of a commercially available LED design lighting apparatus including the light guide plate and an LED light source arranged on one end surface of the light guide plate. Further, a black PET film was bonded to the opposite side of the film for an LED lighting apparatus to the light guide plate. Thus, an LED lighting apparatus was obtained. For the resultant LED lighting apparatus, the ratio of the intensity of light emitted from the light guide plate to the intensity of light entering the light guide plate at a time when the LED light source was turned on was evaluated by the evaluation method (3). The result is shown in Table 1.

### Comparative Example 1

An LED lighting apparatus was obtained by directly bonding a black PET film to the light guide plate of the same LED design lighting apparatus as the LED design lighting apparatus used in Example 1. For the resultant LED lighting apparatus, the ratio of the intensity of light emitted from the light guide plate to the intensity of light entering the light guide plate at a time when the LED light source was turned on was evaluated by the evaluation method (3). The result is shown in Table 1.

### Comparative Example 2

An LED lighting apparatus was obtained by subjecting the light guide plate of the same LED design lighting apparatus as the LED design lighting apparatus used in Example 1 to antifouling treatment with a fluorine-based compound (manufactured by AGC Seimi Chemical Co., Ltd., product name: “SFCOAT”). For the resultant LED lighting apparatus, the ratio of the intensity of light emitted from the light guide plate to the intensity of light entering the light guide plate at a time when the LED light source was turned on was evaluated by the evaluation method (3). The result is shown in Table 1.

TABLE 1

| | | Comparative | Comparative |
|---|---|---|---|
| | Example 1 | Example 1 | Example 2 |
| Configuration | Black PET | Black PET | Antifouling-treated |
| | film/film for | film/light | layer/light guide |
| | LED lighting | guide plate | plate |
| | apparatus/light | | |
| | guide plate | | |
| Void ratio of | 59% | — | — |
| low-refractive | | | |
| index layer | | | |
| Refractive | 1.18 | — | — |
| index of | | | |
| low-refractive | | | |
| index layer | | | |
| Ratio of | 92% | <5% | 80% |
| emitted light | | | |
| intensity to | | | |
| entering light | | | |
| intensity | | | |

As apparent from Table 1, the use of the film for an LED lighting apparatus of the present invention can provide a light guide unit capable of efficiently guiding entering light.

### REFERENCE SIGNS LIST

10 base material

20 low-refractive index layer

30 adhesion layer

40 LED light source

110 film for LED lighting apparatus

120 light guide plate

200 LED lighting apparatus

1. A film for an LED lighting apparatus, comprising:
a base material; and
a low-refractive index layer arranged on at least one side of the base material,
wherein the low-refractive index layer has a refractive index of 1.25 or less and
the low-refractive index layer is a void-containing layer and a porous body formed by chemical bonding between particles.

2. The film for an LED lighting apparatus according to claim 1, wherein the particles are fine porous particles.

3. The film for an LED lighting apparatus according to claim 2, wherein the fine porous particles are fine porous particles of a silicon compound.

4. The film for an LED lighting apparatus according to claim 1, wherein the low-refractive index layer has a void ratio of 35 vol % or more.

5. The film for an LED lighting apparatus according to claim 1,
wherein the low-refractive index layer is arranged on one side of the base material, and
the surface of the base material on the opposite side to the low-refractive index layer is subjected to surface treatment.

6. An LED lighting apparatus, comprising:
a light guide unit including a light guide plate and a film for an LED lighting apparatus, which is arranged on at least one surface of the light guide plate,
wherein the film for an LED lighting apparatus is the film for an LED lighting apparatus of claim 1.

7. An LED lighting apparatus according to claim 6, wherein the outer side of the light guide unit is subjected to surface treatment.

8. An LED lighting apparatus according to claim 6,
wherein the film for an LED lighting apparatus is arranged on the light guide plate in such a manner that the low-refractive index layer is arranged light guide plate side with respect to the base material, and
the surface of the light guide unit on the opposite side to the light guide plate is subjected to surface treatment.

9. The LED lighting apparatus according to claim 6, further comprising a LED light source arranged on one end surface of the light guide plate.

10. The LED lighting apparatus according to claim 6, a difference between a refractive index of the light guide plate and a refractive index of the low-refractive index layer is 0.2 or more.
